(19) United States
(12) Patent Application Publication
(10) Pub. No.: US 2010/0320826 A1
(43) Pub. Date: Dec. 23, 2010

(54) Integrated Mounting Flange For School Bus Seats

(75) Inventors: Erik C. Wilson, Decatur, IN (US); Yogesh D. Aundhkar, Pune (IN); Atul P. Khanapurkar, Pune (IN); Narasimha D. Gupta, Pune (IN)

Correspondence Address: International Truck Intellectual Property Company,, 4201 WINFIELD ROAD, WARRENVILLE, IL, 60555, US

(73) Assignee: International Truck Intellectual Property Company, Warrenvill, IL (US)

(21) Appl. No.: 12/863,071

(22) PCT Filed: Jan. 29, 2008
(86) PCT No.: PCT/IN08/00057

§ 371 Date: Jul. 15, 2010

(51) Int. Cl. B60N 2/68

(52) U.S. Cl. 297/452.18

(57) ABSTRACT

A modified seat frame incorporates a wall riser having an integrated mounting flange to reduce welding operations and to reduce the number of parts required to build and install a modular school bus seat.

### BACKGROUND OF THE INVENTION

1. Technical Field

The present invention relates to school bus seats and more particularly to a flange for mounting a seat riser along a chair support rail of a school bus interior wall.

2. Description of the Problem

School bus seats are built to meet many differing customer specifications. For example, some bus seats must accommodate three point safety belts by providing a compatible upper back rest, other specifications call for a universal child restraint attachment equipped lower frame, while still others provide standard DOT (United States Department of Transportation) seat backs. At the same time customers can specify seats in different widths or heights and can demand various strength requirements.

Differing customers' specifications have required substantially or entirely different component sets from which to assemble the seats. The need to supply such component sets has even occurred with respect to completed vehicles where the vehicle has been moved from one state or municipality to another, based on differing requirements of the new jurisdiction.

Modular construction of bus seat frames is known, one example being taught in U.S. Pat. No. 6,886,889 to Vits et al. FIGS. 18-20 of the Vits '889 patent teach a modular seat based on four major sub-assemblies. The sub-assemblies include a frame assembly, a floor mount assembly, a passive restraint panel and a seat member. The frame assembly in turn comprises a pair of opposed side forms of generally elbow shaped and concave construction, two upright members or posts which support the passive restraint panel, longitudinal front and rear members for mounting between the opposed side forms and cross members between the front and rear members. The frame assembly is supported by a pair of identical pedestals (collectively the floor mount assembly) disposed under the respective side forms. In some embodiments one of the pedestals is replaced by a wall mount bracket best shown in FIG. 27 of the patent.

Current seat designs include numerous fabricated parts and require welds to form joints between frame components and sub-assemblies. The process is labor intensive, adding to the overall seat cost. Frame assemblies must be painted after welds are complete because the welding process would burn off the paint. This process constraint along with the inherent difficulty shipping large seat frames limits sourcing opportunities and necessitates a paint operation in the plant. The prior art design shown in FIG. 2 had a stamped wall-side riser with separate L-section mounting flange. This construction added to the part count and required its own welding operations.

Prior art designs have been complicated and have required frequent tests of production material to ensure that components and welds have not drifted outside of compliance, a particularly important step where substantial heat processing, such as welding, is involved in the seat assembly process. It would be advantageous to eliminate metal to metal welding steps wherever possible.

### SUMMARY OF THE INVENTION

The invention provides a mounting flange integrated with the wall riser for a modular seat frame. The mounting flange is integrated into the stamped wall-side riser, thus eliminating extra components and welds, by providing a turned out lower strip along the bottom edge of the wall riser.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a school bus.

FIG. 2 is a perspective view of a prior art school bus seat frame.

FIG. 3 is a perspective view of a modular school bus seat frame incorporating a wall riser in accordance with a preferred embodiment of the invention.

FIG. 4 is an exploded view of the school bus seat frame illustrated in FIG. 3 better illustrating the wall riser with integrated mounting flange.

FIG. 5 is a perspective view of a wall riser showing the integrated mounting flange.

### DETAILED DESCRIPTION OF THE INVENTION

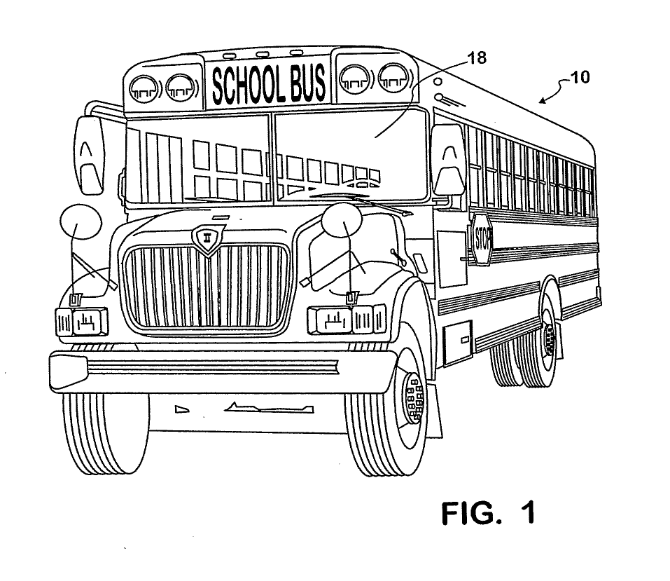

Referring now to the drawings and in particular to FIG. 1, a school bus 10 with which the present invention is advantageously used is illustrated. Seat frames incorporating wall risers with integrated mounting flanges may be installed with one side nestled against an interior wall of the interior 18 of the bus.

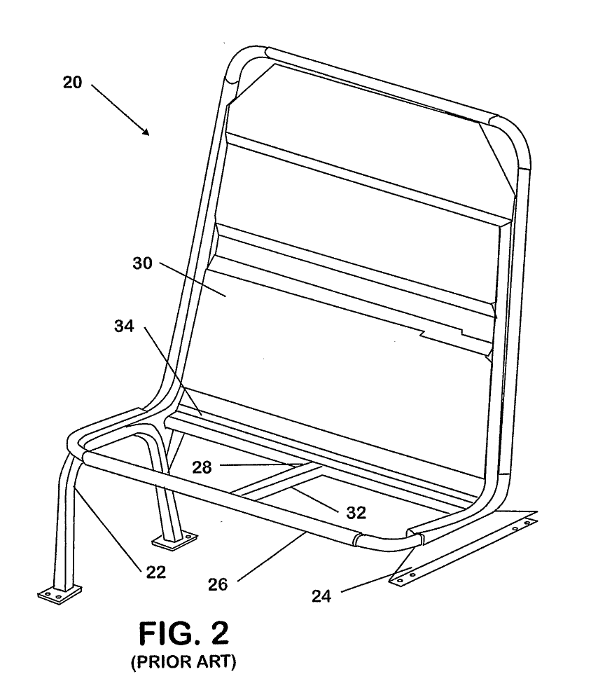

FIG. 2 illustrates a seat frame 20 according to the prior art. A closed loop, multi-piece full perimeter tube 26 outlines the seating area. The full perimeter tube 26 is supported by an aisle riser 22 and a wall riser 24. Wall riser 24 is constructed by welding together at least two plates. An internal frame 28 and a back seat support 30 are nestled within the closed perimeter tube 26. Excluding the risers 22, 24, virtually none of the components are reusable should seat specifications, such as width, or height of the seat back be changed. Internal frame 28 parallels portions of the perimeter tube 26, reinforcing the sides of the perimeter tube and adding a seat back bottom brace 34 and a cross member 32 to give the frame 20 rigidity.

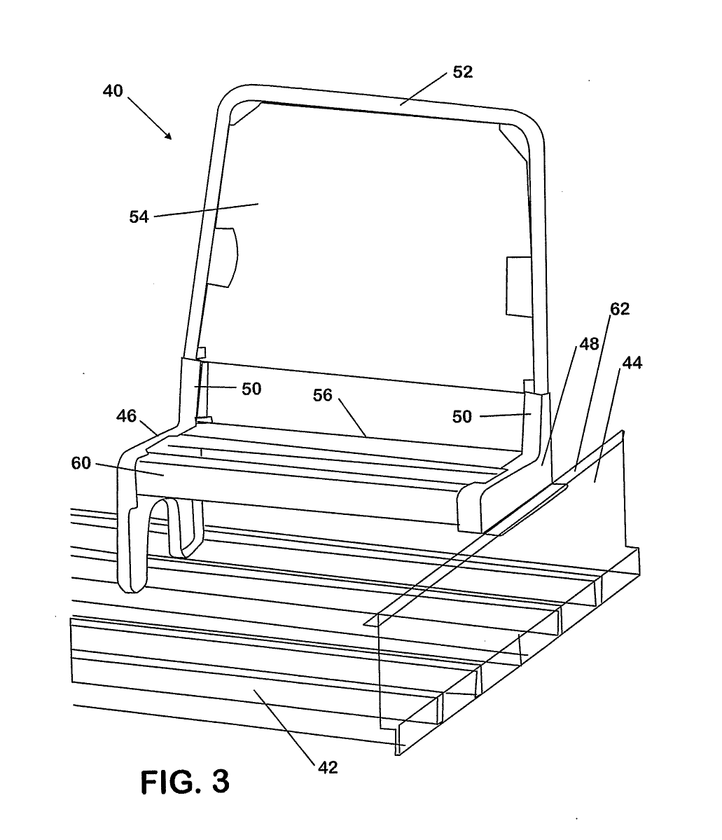

Referring to FIG. 3, an assembled modular school bus seat frame 40 is illustrated disposed on the floor 42 (shown in phantom). Modular frame 40 is supported on its inside end by attachment of wall riser 48 which is mounted to a chair rail 62 of a school bus interior wall 44 (shown in phantom). Modular school bus seat frame 40 thus is supported both from the floor 42 and from the wall 44. Support from the floor 42 is provided by an aisle riser 46. Support from the wall 44 is provided by a wall riser 48. Aisle riser 46 and wall riser 48 differ from the aisle risers and floor risers known from the art in that they form part of what would traditionally be considered the frame itself. Both the aisle riser 46 and the wall riser 48 are modified to function as frame elements, in part by inclusion of necks 50 which provide bases of support for an open, partial perimeter tube 52 used to define the top and sides of a seat back portion of frame 40. In addition, wall riser 48 is formed 72 from a one piece stamping which provides a riser integrated mounting flange for attachment to the chair rail 62. Extending between and fitted into the aisle riser 46 and the wall riser 48 are front and back latitudinal supports 60 and 56. Supports 56 and 60 come in varying lengths to support seats of varying widths. Risers 46 and 48 are stamped elements with interior (i.e. facing) sides which are contoured to reinforce the riser and to provide convenient points of attachment for the front and rear cross member supports 60, 56.

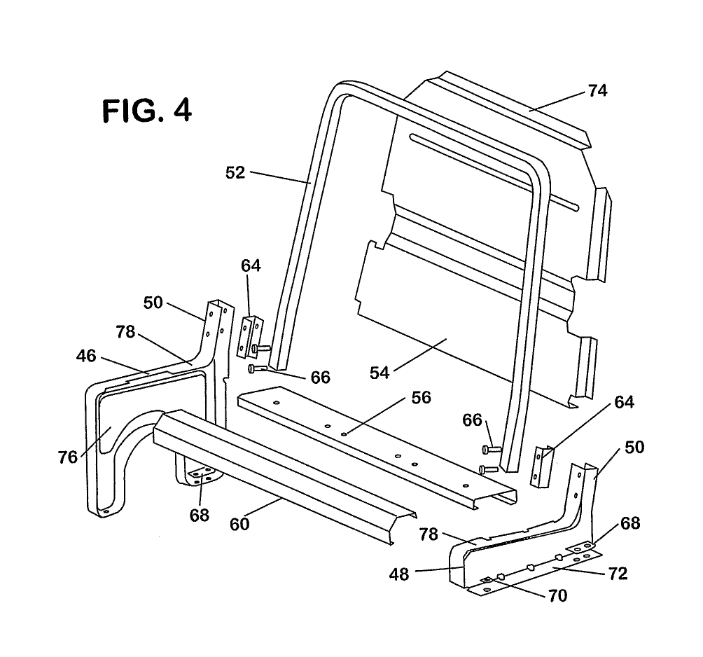

FIG. 4 illustrates the modular seat frame 40 in an exploded view which better illustrates the contours of risers 46, 48 and cross supports 56, 60, which meet to provide the joints. Necks 50 are formed from C-channel sections extending upwardly from the upper rearward areas of aisle riser 46 and wall riser 48. The channels are open one with respect to the other. Open perimeter tube 52 fits into the necks 50 at its opposite ends. The joint formed by joining the ends of the perimeter tube 52 to the necks 50 is reinforced by addition of an U-reinforcement member 64 which fits into the neck 50 between the tube 52 and the interior of the necks 50. Bolts 66 are inserted through the walls of the necks 50, U-reinforcement members 64 and the ends of perimeter tube 52.

In one embodiment, back panel 54 includes a partial perimeter flange 74 by which the panel is attached to tube 52. Risers 46, 48 include inner face contours 76 which position the ends of rear and front supports 56, 60. Risers 46, 48 have integral inwardly turned flanges 78 along their top and front edges. In addition, risers 46, 48 have a back edge flange 71, which are also inwardly turned. Flanges 71 and 78 provide surfaces against which opposite surfaces of the front and rear cross members 60, 56 may be placed to be secured by self pierce rivets (not shown), or other methods such as low temperature welding. Front cross member 60 is substantially formed in three panels, front panel 61, intermediate panel 63, and top panel 65 with panel 63 being intermediate to panels 61 and 65. Cross members with alternative cross sectional profiles are possible. The angle between panels 61 and 65 corresponds to the angle between the front and top edge sections of flange 78, allowing the cross member to be brought into contact with both portions of the flange concurrently. Panel 63 intersects both panels 61 and 65 obliquely along the respective interior side (i.e. the underside of the member relative to the risers) and positioned between the two panels functions as a cross brace between the flange 78 portions.

Rear cross member 56 incorporates two major sections, a top section 57 and a back section 59. The ends of top section 57 and back section are angled (essentially a right angle) to allow them flush mating of the sections to the under surface of the top portion of flange 78 and the forward surface of flange 71. Self pierce rivets (not shown), adhesives or welds are used to attach either member 60, 56 to the riser.

Aisle riser 46 includes legs which support the structure from the floor. A plate 68 is provided for securing fasteners between the riser 46 and a vehicle floor. Wall riser 48 includes an integrated mounting flange 72 allowing securing of the wall riser 48 to a wall support. Attachment plate 68 and washer 70 are used in mounting the riser to the wall support.

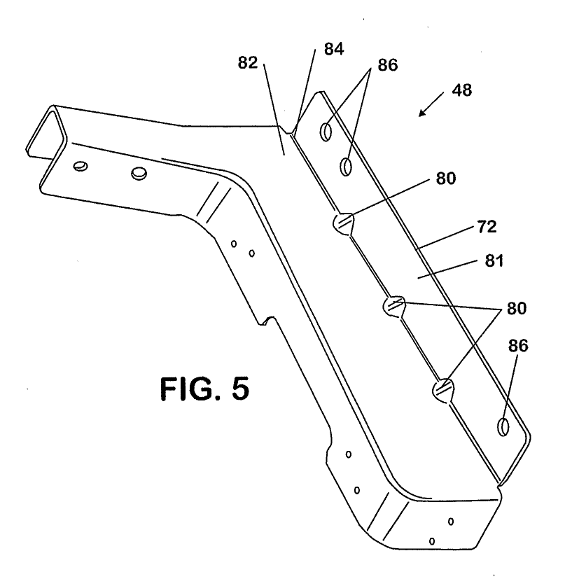

FIG. 5 is a perspective view of the wall riser 48 of the preferred embodiment where a mounting flange 72 has been formed in a one piece stamping joined at a right angle to adjacent portions of the main body 82 of the wall riser. Mounting flange 72 is located along a lower edge of the main body 82 of the wall riser 48, connected along a right angle bend 84 which is interrupted only by three reinforcement darts 80, which resist changes in the overall shape of the riser. The mounting flange 72 is flat and orients the riser 50 on the chair rail upon positioning of the riser. The flat upper 81 and lower (not shown) major surfaces are horizontal and parallel to the floor of the vehicle after installation. Three holes 86 are located in flange 72, connecting the upper and lower major surfaces of the flange. The holes 86 provide points for the insertion of conventional fasteners/darts for connecting the flange 72 to the chair rail 62. Flange 72 is positioned on the major body 82 to be horizontal upon positioning of a completed seat frame in a bus for installation.

While the invention is shown in only a few of its forms, it is not thus limited but is susceptible to various changes and modifications without departing from the spirit and scope of the invention.

1. A bus seat wall riser comprising:
a main body and a mounting flange extending at substantially a right angle from a lower edge of the body, the body and mounting flange being stamped from an integrated piece; and
the mounting flange being straight and flat for attachment to a chair support of a bus interior wall.

2. A bus seat wall riser as set forth in claim 1, further comprising:
a joint along which the main body and mounting flange are attached; and
reinforcement darts in the joint for resisting bending moments applied between the main body and the mounting flange.

3. A bus seat wall riser as set forth in claim 2, further comprising:
the mounting flange running along substantially the full length of the main body.

4. A modular seat frame comprising:
a bus seat wall riser;
the bus seat wall riser including a main body and a mounting flange extending at substantially a right angle from a lower edge of the body, the body and mounting flange being stamped from an integrated piece; and
the mounting flange being straight and flat for attachment to a chair support of a bus interior wall.

5. The modular seat frame of claim 4, further comprising:
a joint along which the main body and mounting flange are attached; and
reinforcement darts in the joint for resisting bending moments applied between the main body and the mounting flange.

6. A modular seat frame of claim 5, further comprising:
the mounting flange running along substantially the full length of the main body.
